(19) United States
(12) Patent Application Publication
(10) Pub. No.: US 2007/0028480 A1
(43) Pub. Date: Feb. 8, 2007

(54) Conveying Unit And Dryer, Comprising A Board Deviation Detection Circuit

(75) Inventors: Michel Capron, Hochstatt (FR); Michel Gineste, Ungersheim (FR); Jacky Fretz, Bergholtz (FR); Pierre Scalzitti, Mulhouse (FR); Jean-Paul Vonthron, Bruebach (FR)

Correspondence Address: BUCHANAN, INGERSOLL & ROONEY PC, POST OFFICE BOX 1404, ALEXANDRIA, VA, 22313-1404, US

(73) Assignee: LAFARGE PLATRES, Avignon Cedex 9 (FR)

(21) Appl. No.: 11/420,528

(22) Filed: May 26, 2006

Related U.S. Application Data
(63) Continuation-in-part of application No. PCT/FR04/03064, filed on Nov. 30, 2004.

(30) Foreign Application Priority Data
Dec. 5, 2003 (FR) 03 14 301

(51) Int. Cl. B65G 43/08

(52) U.S. Cl. 34/217; 198/401

(57) ABSTRACT

A board-conveying unit includes a board conveyor that defines a path; and a board deviation detection circuit, which includes a contact switch; in which unit the contact switch comprises at least one contact element extending along the path and is able to move in an oblique direction relative to the path, in which the first conductor is designed to be displaced by a board as said board overlaps another board.

The invention relates to a novel conveying unit which comprises a board deviation detection circuit and to a board dryer having such a unit, especially a plasterboard dryer.

Units for manufacturing board materials, such as wooden boards or plasterboards, are known.

For example, plasterboard manufacturing units generally comprise a station for preparing the plaster slurry, a station for depositing the slurry on a reinforcing material, a station for forming and coating the upper face of the slurry with another reinforcing material, a station for hydrating the plaster, a station for cutting the boards, a transfer station, a board dryer (or drying station, also called an oven) and a cutting and packaging station.

The dryers generally comprise several stages—the length of the dryers may typically exceed 100 metres. Inside a dryer, boards are conveyed along conveying units. A board dryer may for example include (or be connected to) a combustion boiler for generating hot gases.

In a conveying unit, it may happen that boards may suffer a deviation and/or overlap one another (also called “start of a jam”). This may create a board jam along a conveying path. A jam is penalizing as it requires the drying operation, or even an entire board production line, to be stopped. Work to return the conveying unit to normal operation, that is to say “unjamming” work, is then necessary. Unjamming work is lengthy, difficult and dangerous, especially because it is carried out in a hostile environment owing to the heat, or even the presence of noxious gases. At the end of the day, a board deviation and, consequently, a jam and work to clear the jam may have deleterious consequences both from the human standpoint and the industrial standpoint.

Light signal sensors placed above a conveying path and transversely to this path are known. For example, U.S. Pat. No. 5,130,558 describes light signal sensors used especially for local detection of an envelope jam. However, monitoring a conveying unit over its entire length requires the use of a plurality of such sensors, which is technically difficult to implement (not very ergonomic) in the case of long conveying lengths, typically greater than 100 m. This method is therefore not suitable for monitoring a board-conveying unit over its entire length.

WO 00/12277 discloses a method for the continuous manufacture of gypsum plaster panels, making it possible to detect a tear or a local defect in a panel support and/or covering paper. Here again, such a method is not suitable for monitoring a board-conveying unit over its entire length. It therefore does not allow the start of a jam to be detected.

U.S. Pat. No. 5,678,322 discloses a wood veneer panel dryer comprising a conveyor for transporting the panels from a first end of the dryer to a second end of the dryer. A device directs a laser beam above the conveyer and the laser device produces a signal representative of the distance between the device and an object passing through the laser beam.

However, such a device is unsuitable for board dryers of long conveying length (typically greater than 100 m), in which the temperature gradients are such that they alter the beam and, consequently, generate erroneous signals, causing inopportune stoppages of the dryer.

There is therefore a need for a board-conveying unit, for a method of detecting the deviation of a board, and for a method generating an electrical signal representative of such a deviation which solve these problems.

For this purpose, the invention proposes a board-conveying unit, comprising board-conveying means that define a path, and a board deviation detection circuit, which includes a contact switch, in which unit the contact switch comprises at least one contact element extending along the path and able to move in an oblique direction relative to the path.

In preferred embodiments, the invention comprises one or more of the following features:
the contact element is a first electrical conductor, above the conveying means; the circuit furthermore has a second electrical conductor above the first conductor; and the first conductor is designed to come into contact with the second conductor at a point of contact;
the circuit furthermore has a detector for measuring an electrical quantity that depends on the position of the point of contact;
the circuit furthermore has a generator, one terminal of the generator being grounded and the other terminal of the generator being connected to the first conductor and the second conductor is grounded;
the second conductor is a metal part of the unit;
the contact element is supplied with a voltage of less than 200 mV and preferably less than 100 mV;
the contact element is a steel wire;
the contact element is a metal strip;
the contact element is connected to a plurality of electrically insulating supports;
the contact element is at a distance of between 15 and 50 mm from the conveying means;
the conveying unit according to the invention furthermore includes an alarm system connected to the detection circuit;
the conveying unit according to the invention furthermore includes a plurality of flaps, for access to the conveying means, and also a user interface comprising means suitable for indicating one access flap from among the plurality, this flap corresponding to a point of contact of the contact element.

The invention also provides a board dryer, comprising at least one conveying unit according to the invention.

In a variant, the dryer according to the invention furthermore includes plasterboards on the conveying means.

The invention furthermore provides a method of drying plasterboards in a dryer according to the invention, comprising a step of delivering plasterboards to the conveying means of the unit according to the invention.

The invention also provides a method of detecting any deviation of a board in a conveying unit according to the invention, which comprises the steps: (a) of displacement of the contact element by a board (14) deviating from the path defined by the conveying means (12); and (b) of closing the switch of the detection circuit at a point of contact.

In preferred embodiments, the board deviation detection method according to the invention comprises one or more of the following features:
it furthermore includes a step (c) of comparison by the circuit of an electrical quantity with a threshold value;
the quantity compared in step (c) of their method depends on the position of the point of contact.

The invention furthermore proposes a method of generating an electrical signal representative of the deviation of a board in a conveying unit, the method comprising the steps of: (a) passing a current through a first conductor designed to come into contact with a second conductor at a point of contact; (b) measuring an electrical quantity of a circuit comprising the first and second conductor; and (c) generating a signal on the basis of the measurement in step (b).

In a variant, step (b) of this method is a step of measuring the resistance of a portion of the first conductor, this portion being on one side of the point of contact.

Other features and advantages of the invention will become apparent on reading the following description of embodiments of the invention, these being given by way of example and with reference to the appended drawings which show:

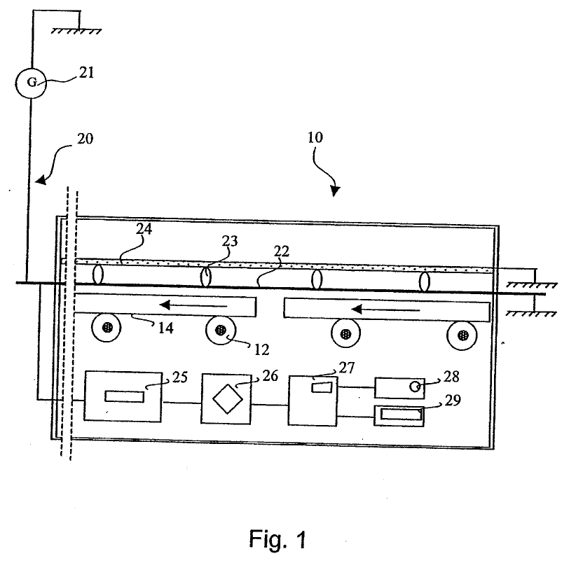

FIG. 1: a diagram of a conveying unit according to the invention, not drawn to scale, when there is no board deviation; and

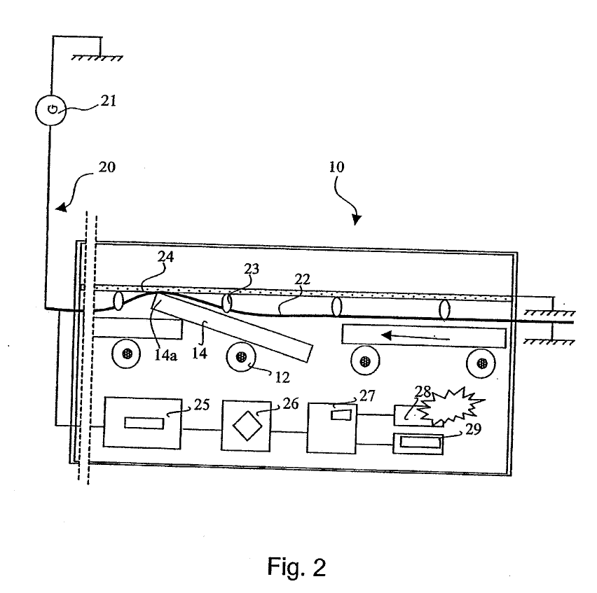

FIG. 2: a diagram of a conveying unit according to the invention, not drawn to scale, when there is a board deviation.

The invention proposes a board-conveying unit which comprises board-conveying means, which define a path, and a board deviation detection circuit. The board deviation detection circuit comprises a contact switch. The contact switch comprises at least one contact element, along the path. This element can move in an oblique direction relative to the path, for example in a direction approximately perpendicular to the path. The start of a board jam thus results in a displacement of the contact element of the switch of the circuit, which displacement closes the circuit. The conveying unit is thus suitable for detecting the start of a board jam in a dryer that may have a very long conveying length (typically greater than 100 m). The detection circuit of the conveying unit is insensitive to temperature gradients. The generation of erroneous signals, causing inopportune stoppages of the dryer, is thus avoided. Furthermore, installation and maintenance of such a detection circuit poses no substantial difficulty, owing to the simplicity and effectiveness of the technology involved.

FIG. 1 shows schematically a conveying unit according to the invention.

In the embodiment illustrated in the figure, a dryer includes a board-conveying unit 10 comprising a conveying stage. Only one conveying stage is shown for the figure simplicity. However, it should be borne in mind that a conveying unit may typically comprise around ten stages. In the stage shown in FIG. 1, conveying means 12, comprising spaced-apart rollers 12, define a conveying path shown symbolically by horizontal arrows in FIG. 1. These rollers 12 convey boards 14, for example plasterboards. They are suitably spaced apart in order to allow a board to be transported without any damage. For example, the rollers may be spaced apart by 100 to 200 mm at the inlet of a dryer and 200 to 400 mm at the outlet, in particular when the dryer is a plasterboard dryer (which will be described later).

FIG. 1 shows a “normal” conveying situation, that is to say one in which the boards are conveyed without any deviation, without jamming, etc. by the rollers 12. Typically, the dryer is a dryer for drying plasterboards, which are conveyed along the conveying path.

The unit 10 also includes a board deviation detection circuit 20. The circuit 20 has a movable contact element 22. This movable contact element extends along the path defined by the conveying means 12.

In the embodiment illustrated in FIG. 1, the movable contact element 22 is a first electrical conductor 22, for example a stainless steel wire, which lies above the conveying means 12 and is grounded. The detection circuit furthermore includes a second electrical conductor 24 with which a region of the first conductor 22 can be brought into contact (this will be specifically described with reference to FIG. 2). The second conductor is also grounded.

The circuit 20 may also include support elements 23, intended to keep the first conductor 22, that is to say the stainless steel wire, in place above the conveying means 12. These supports are, for example, connected on one side to the second conductor and on the other side to the first conductor. These supports 23 are insulating, so that there is no electrical contact between the two conductors 22, 24 in the normal board conveying situation, as illustrated in FIG. 1. Also preferably, these supports 23 exhibit good temperature stability (typically withstanding temperatures up to 400° C.), so that they can be used in a conveying unit 10 intended for a board dryer. The supports 23 may for example be, or comprise, a ceramic part. Furthermore, these elements are designed to withstand any heating of the first conductor. These supports 23 may also include at least one elastic or deformable part, or else one that may be configured (for example in the form of a folded ring) so as to allow displacement of the first conductor 22 even at these supports 23 (for example a vertical displacement in FIG. 1).

The circuit 20 also has an electrical generator 21, one terminal of which can be grounded, as in the example shown in FIG. 1. It also has a detector 25 for measuring an electrical quantity, the said detector 25 being connected to the first conductor 22 and optionally grounded. A module 26 is connected to the measurement detector 25 and is responsible for comparing the electrical quantity with one or more threshold values.

In one embodiment, the measurement and the comparison of the electrical quantity take place immediately after the circuit has been closed by the movable contact element 22 (the first conductor 22 in FIG. 1), as will be described below.

In a variant, the measurement and the comparison of the electrical quantity take place periodically. This point will also be discussed later.

A user interface 27 is connected to the module 26, and also to an alarm 28 and a display 29. The elements 25 to 29 of the circuit may be combined into a single module or else they may be separate, depending on the installation and maintenance contingencies.

The interface 27 may have various keys, allowing an operator to input circuit parameters. Thus, the operator may for example input one or more threshold values of an electrical quantity, this quantity being, for example, a voltage, or he may input an electrical-quantity response function. This will also be described later.

The method detecting any deviation of a board in a conveying unit according to the invention will now be described with reference to FIG. 2.

FIG. 2 shows schematically a conveying unit according to the invention and comprises the same elements already described with reference to FIG. 1. In a conveying unit 10, such as that shown in FIGS. 1 and 2, a board 14 is placed onto the conveying means 12 of the unit 10, in such a way that the board follows a “normal” trajectory along the path defined by the conveying means 12. When, for an accidental reason or for the purpose of testing, a board 14 deviates from its normal trajectory, it may for example have one end 14a raised up. The raised-up end 14a of the board 14 then comes into contact with the first conductor 22. Given that this first conductor 22 can move in an oblique direction relative to the plane of the conveying path (in particular perpendicular to this plane, i.e. vertically in FIG. 2), the board 14 causes, when it deviates from its normal trajectory, displacement of the first conductor 22 towards the second conductor 24. When the first conductor 22 reaches the second conductor 24, it closes the detection circuit.

The use of elastic or deformable supports 23 allows the displacement (for example vertical displacement in FIG. 2) of the first conductor 22 even at these supports 23, so that deviation of a board can be detected at any point along the first conductor 22.

The first conductor 22, i.e. a wire 22 in the example described here, therefore fulfils the function of a contact element of a switch, while the second conductor 24 acts as a fixed terminal of this switch. Likewise, a conducting portion upstream of the first conductor 22, towards the generator, also fulfils the function of another fixed terminal of the switch.

In one embodiment, the generator 21 is a current generator, generating a low current in the first conductor 22, at a typical voltage of 50-250 mV in the absence of any contact between the two conductors 22, 24. The detector 25 is a voltage detector, connected to the first conductor 22 in such a way as to measure, for example, a voltage U equivalent to that across the terminals of the generator 21. The detector 25 may for example be grounded (not shown). The first conductor presents a constant resistance per unit length r (typically 0.1 to 1 ohms per metre) to the flow of the current. The overall resistance R of the first conductor 22 (typically between 10 and 200 ohms) is therefore proportional to the total length of this conductor 22 in the absence of any contact between the two conductors 22, 24. When a board deviates from its trajectory, it causes displacement of the first conductor and, consequently, a contact between the conductors 22, 24 at a point of contact of the first conductor 22. Such a contact closes the circuit.

Preferably, closure of the circuit by the first conductor 22 triggers an alarm signal (shown symbolically by a flash in FIG. 2).

The conveying unit according to the invention is thus suitable for detecting deviation of a board and, among other things, the start of a board jam.

The current, which was flowing hitherto in the first conductor, can suddenly flow into the second conductor 24. Thus, the apparent resistance seen by the flow of current drops to an effective resistance value R′ (R′<R), which in turn results in a voltage drop.

The ohmic value of the circuit, comprising the first conductor 22 and the second conductor, which are grounded, follows a linear law, for example of the type:
y=rx+Rₘ

where r represents the resistance per unit length and Rₘ represents the resistance resulting from the body of the dryer. In this case, when there is no contact between the first and second conductors, the ohmic value of the circuit is given by:
y=rL+Rₘ

L representing the total length of the wire, the overall resistance R (no contact) of the first conductor 22 being given by R=rL. When there is a contact between the first and second conductors, the ohmic value of the circuit becomes:
y=rx′+Rₘ

where x′ represents the position of contact between the conductors, and rx′ is equivalent to the effective resistance of the first conductor, i.e. R′ using the above notation.

Typically, the detector 25 then measures and transmits a voltage value U′ to the module 26. The measured voltage U′ therefore acts as an electrical quantity whose value is sensitive to any contact between the conductors 22, 24, that is to say sensitive to the position of the first conductor 22. The module 26 compares the voltage value U′ with a threshold value. If the voltage U′ is less than a threshold value Uₜ, it transmits a corresponding signal to an interface 27, which may in turn transmit an appropriate signal to a display 29. This results in information being displayed on the display 29.

The conveying unit is thus designed to detect any deviation of a board and to display corresponding information.

An operator is thus immediately informed of the anomaly, right at the start of a jam. He can therefore take the necessary measures to solve the jamming problem. Since the deviation is detected very early, any damage is limited.

Preferably, closing the circuit does not stop the boards from being conveyed. However, the operator may, after having detected an anomaly, issue a command to stop the conveying of the boards, or at the very least to slow this down.

As a variant, the module 26 or the interface 27 issues a command for the conveying to stop immediately, for example by transmitting an appropriate signal to an operating circuit for the conveying means or by interrupting an appropriate signal thereat.

According to another variant, the module 26 or the interface 27 issues a command to stop the conveying only after a time delay, so as to avoid an inopportune stoppage associated with a localized deviation or overlap.

Furthermore, upon contact between the two conductors 22, 24, the voltage measured by the detector 25 varies in correspondence with the value of the effective resistance of the first conductor 22, going from R to R′. R′ is proportional to the length of the first conductor 22 upstream of the point of contact between the two conductors 22, 24. The circuit thus measures an electrical quantity, for example the voltage, dependent on the position of the point of contact.

It is possible, for example, by means of suitable prior parameter input with a set of threshold voltages Uₜ₁ . . . U_{tN} or with a function of the “position of contact”=f(U′) type for determining the position of the point of contact by testing the value of the voltage U′. The parameter input with this set of voltages or with the “position of contact” function is simple to implement, for example using a trial-and-error method, whereby a set of voltages or a function is postulated and the procedure described below is tested out for various points of contact between the two conductors 22,24. Thus, the module 26 may transmit a signal corresponding to the position of the point of contact to the interface. The interface 27 can then in turn transmit this position to the display 29.

Thus, an operator can locate the place where the deviation or the start of a jam occurs. During parameter input, if it turns out that the displayed position does not correspond to the actual position of the board deviation, an operator must postulate a new set of voltages or a new function, and so on. In practice, a suitable set of voltages is simple to determine for a person skilled in the art, according to the electrical characteristics of the circuit.

As a variant, it is possible to use a voltage generator 21 and to detect, for example, a change in current, using a circuit similar to the previous one except for a few modifications, within the normal competence of a person skilled in the art. For example, it will be necessary to connect the detector in series with a section of the first conductor or with a conductor connected to the latter.

As a variant, it is possible to use an AC generator 21, making a few changes to the connection, within the normal competence of a person skilled in the art. Controlling the total high-frequency impedance of the dryer/wire assembly allows the precision of the electrical measurements and the repeatability to be typically improved.

Relying on a physical contact between two conductors has many advantages. For example, this type of contact is not sensitive to a local index variation of the air, for example due to a temperature gradient. Furthermore, this type of contact is insensitive to the presence of steam or condensation, and is inexpensive. Consequently, a board-conveying unit according to the invention is suitable for detecting the start of a jam in various environments (presence of hot gases, condensation, temperature gradient), and to do so without any substantial difficulty in installation and maintenance.

Preferably a low current flows through the first conductor, typically at a voltage of less than 200 mV and preferably less than 100 mV. Thus, a detection circuit in a conveying unit according to the invention does not require substantial power consumption.

In a variant, the second conductor is a metal part of the framework of the conveying unit, for example a coil, a beam or a conveying roller support. Thus, use is made of the existing structure of a conveying unit.

In a variant, the first conductor 22 is a metal strip, allowing improved contact and more rapid detection.

A conveying unit 10 according to the invention may furthermore include a plurality of access flaps or doors placed along the conveying means 12, so as to make any intervention by an operator easier, for example in the event of a jam starting.

The invention also provides a dryer, for example one for drying boards, which comprises one or more conveying units 10 according to the invention combined with a heating system.

A dryer according to the invention may be more particularly intended for drying plasterboards. In this case, it is advantageous to provide it with a conveying unit in which the first conductor is located, for example, at a distance of between 15 and 50 mm from the conveying means. In this way, the conveying unit, and hence the dryer, are suitable for drying plasterboards of variable thickness. In addition, a wide variety within the standard range of plasterboards usually produced is compatible with a conveying unit and a dryer according to the invention.

In a variant, the height of the insulating supports of the first conductor can be adjusted so as to be able to easily adapt the detection circuit to variable board thicknesses.

In the embodiment illustrated by FIGS. 1 and 2, the conveying unit comprises only a single conveying stage, so as to make its description easier. However, it is clear that a conveying unit may, in another embodiment, typically comprise several stages and a dryer according to the invention may typically comprise one or more multi-stage conveying units. In such a case, board-conveying means are provided at each stage.

It is possible to provide, in a variant, a detection circuit common to the entire dryer and to parameterize the circuit elements accordingly. If necessary, this circuit comprises a single detector, a single module and a single interface. These components are then electrically connected, in a suitable manner, to the movable contact elements of each of the stages and, where appropriate, of each of the conveying units. Such a solution allows centralized detection. Furthermore, such a solution limits the number of detection circuit components and thus limits, statistically, the risk of a breakdown.

In a typical example of a dryer according to the invention, the conveying unit comprises eight stages. The dryer measures between 100 and 200 m in length and comprises between 50 and 100 doors per stage, these doors giving access to the conveying means, i.e. to the inside of the dryer. A door therefore typically covers a width of about 2 m. A stainless steel wire is held taut in each of the stages and over the entire length of the dryer. Counterweights, for example placed at the ends of the dryer, tension the wires. Typically, these counterweights have masses of between 10 and 60 kilograms, preferably between 20 and 40 kilograms, suspended from a wire returned by a return element to one end of the dryer. The wires are supported by temperature-resistant insulating support elements spaced 10 m apart on average. At rest, the wires are at a mean height of 35 mm above the conveying rollers, allowing passage of standard (for example 25 mm) boards. The metal body of the dryer acts as the second conductor. When there is contact between the steel wire and the metal mass, the change of ohmic value of the circuit is detected (via a voltage) and interpreted in an electrical interface. A local alarm is triggered by the detection circuit (the alarm comprises a hooter and, if necessary, a luminous signal). The interface then tests the circuit inputs corresponding to each of the stages and displays, for each stage, a door number corresponding to the circuit/stage ohmic value. If no ohmic loss is measured for a given stage, the interface displays the number of the last door, indicating that there was no contact in the stage. A number below that of the last door will be displayed in order to indicate a contact in the stage in question. This number corresponds to the point of contact between wire and body of the stage in question, with an uncertainty due to the low current, the resistance of the wire, the temperature and, more generally, the industrial environment. This uncertainty is typically one to three doors (i.e. about 2 to 6 m) around that whose number has been displayed, depending on the electrical characteristics of the circuit. The interface is, for example, located downstream of the dryer, close to the last door. It is housed in a cabinet, together with the display, the local alarm, an alarm stop switch and a general isolator. In the event of the alarm being triggered (intermittently or continuously) an operator goes to the cabinet, notes the number of the door indicated and then goes to that door. After opening the door, he can visually inspect the flow of the boards and also the wire tension (particularly in the event of intermittent triggering of the alarm). If the start of a jam is observed, the operator stops the manufacture, and possibly the fans, and he can then start the “unjamming” procedure. In this case, the unjamming procedure is all more simple, the earlier the start of the jam is detected. If no defect is observed, the operator repeats the procedure for the adjacent door, and so on.

As a variant, it is possible to provide one generator and/or one detector per stage and to use one module and/or one interface common to the conveying unit. This makes it possible to maintain a certain independence per stage. For example, a breakdown in one of the generators and/or detectors prevents detection only at one of the stages, without disturbing detection at the other stages. However, the control operations may be carried out by an operator from a single interface, common to the entire conveying unit.

In another variant, it is possible to provide, however, a detection circuit specific to each of the stages of the conveying unit.

In a variant, the measurement and the comparison of the electrical quantity (for example the voltage) are not carried out specifically after the circuit has been closed by the first conductor 22. The measurement and the comparison of the electrical quantity may for example be carried out periodically. It should be noted in this regard that it is unnecessary for the frequency of measurement and comparison to be high. For example, a frequency of measurement/comparison every two minutes is acceptable, taking into account the characteristic speed of advance of the boards in the dryer. Such a frequency corresponds, in the case of a dryer comprising twelve stages with three channels for advancing the boards (three abreast), i.e. three wires per stage, to a wire measurement about every three seconds, which poses no major implementation problems from the electronics standpoint.

It should be noted that a heating circuit of the dryer may act as the second conductor, with which the movable contact element can come into contact should there be a deviation of a board, in a dryer according to the invention. All that is required to do this is for the heating circuit to be made of a conducting material, for example a metallic material, or to have an external metal coating.

According to another variant, the tension in the wires (first conductors 22) is provided by springs or bungees rather than by counterweights.

According to another variant, the insulating supports for the wires have one part that is grounded, preferably an upper part. In this way, any lifting of the first conductor 22 at a support results in anticipated contacting by the first conductor and thus allows anticipated detection of the start of a jam.

According to another variant, the insulating supports for the wires are connected, via an upper part, to a transverse bar fixed to the structure of the dryer. This transverse bar may be aligned in the same direction as the conveying rollers. Several insulating supports, corresponding to the same number of conveying paths, may be connected to one and the same bar if the dryer comprises several parallel conveying paths.

According to another variant, the first conductor 22 (for example a stainless steel wire) is subjected to a to-and-fro movement along the conveying path. Such a movement makes it possible to improve the electrical contact between the conductors 22 and 24, and thus compensates for any oxidation of one of the conductors 22 and 24.

The present embodiment, variants and examples must be considered as having been presented by way of illustration and without restriction, and the invention is not assumed to be limited to the details provided here but can be modified while still remaining in the scope of the appended claims. For example, it is possible to provide, within the scope of the appended claims, a plurality of movable contact elements in the form of a nail (or of any cylindrical metal rod provided with a retention head at one end of the rod), passing through a plank and retained by the head. Typically, this plank is made of a conducting material and forms, with the nails, the first conductor. When a board deviates, the lower end of a suspended nail is moved by the board and the head of the nail comes into contact with the second conductor of the conveying unit, closing the detection circuit.

1. A board-conveying unit, comprising:
a board conveyor that defines a path; and
a board deviation detection circuit, which includes a contact switch;
in which unit the contact switch comprises at least one contact element extending along the path and is able to move in an oblique direction relative to the path, in which the first conductor is designed to be displaced by a board as said board overlaps another board.

2. The conveying unit of claim 1, in which:
the contact element is a first electrical conductor, above the conveying means; and
the circuit furthermore has a second electrical conductor above the first conductor;
and in which the first conductor is designed to come into contact with the second conductor at a point of contact.

3. The conveying unit of claim 2, in which the circuit furthermore has a detector for measuring an electrical quantity that depends on the position of the point of contact.

4. The conveying unit of claim 2, in which:
the circuit furthermore has a generator, one terminal of the generator being grounded and the other terminal of the generator being connected to the first conductor; and
the second conductor is grounded.

5. The conveying unit of claim 2, in which the second conductor is a metal part of the unit.

6. The conveying unit of claim 1, in which the contact element is supplied with a voltage of less than 200 mV.

7. The conveying unit of claim 1, in which the contact element is supplied with a voltage of less than 100 mV.

8. The conveying unit of claim 1, in which the contact element is a steel wire.

9. The conveying unit of claim 1, in which the contact element is a metal strip.

10. The conveying unit of claim 1, in which the contact element is connected to a plurality of electrically insulating supports.

11. The conveying unit of claim 1, in which the contact element is at a distance of between 15 and 50 mm from the conveying means.

12. The conveying unit of claim 1, which furthermore includes an alarm system connected to the detection circuit.

13. The conveying unit of claim 1, which furthermore includes a plurality of flaps, for access to the conveying means, and also a user interface comprising means suitable for indicating one access flap from among the plurality, this flap corresponding to a point of contact of the contact element.

14. A board dryer, comprising a board-conveying unit, said board-conveying unit comprising:
board-conveying means that define a path; and
a board deviation detection circuit, which includes a contact switch;
in which unit the contact switch comprises at least one contact element extending along the path and able to move in an oblique direction relative to the path, in which the first conductor is designed to be displaced by a board as said board overlaps another board.

15. The dryer of claim 13, which furthermore includes plasterboards on the conveying means.

16. A method of drying plasterboards in a dryer, where said board dryer comprises a board-conveying unit, said board-conveying unit comprising:
a board conveyor that defines a path; and
a board deviation detection circuit, which includes a contact switch;
in which unit the contact switch comprises at least one contact element extending along the path and able to move in an oblique direction relative to the path, in which the first conductor is designed to be displaced by a board as said board overlaps another board;
said method comprising a step of delivering plasterboards to the conveying means of the unit.

17. A method of detecting deviation of a board in a conveying unit, said board-conveying unit, comprising:
a board conveyor that defines a path; and
a board deviation detection circuit, which includes a contact switch;
in which unit the contact switch comprises at least one contact element extending along the path and able to move in an oblique direction relative to the path, in which the first conductor is designed to be displaced by a board as said board overlaps another board,
said method comprising the steps:
a) of displacement of the contact element by a board deviating from the path defined by the conveyor; and
b) of closing the switch of the detection circuit at a point of contact.

18. The method of claim 17, in which step (a) is a step of displacement of the contact element (22) by the board, as the board overlaps another board.

19. The method of claim 17, which furthermore includes a step:
c) of comparison by the circuit of an electrical quantity with a threshold value.

20. The method of claim 19, in which the quantity compared in step c) depends on the position of the point of contact.

21. A method of generating an electrical signal representative of the deviation of a board in a conveying unit, the method comprising the steps of:
a) passing a current through a first conductor designed to come into contact with a second conductor at a point of contact;
b) measuring an electrical quantity of a circuit comprising the first and second conductor; and
c) generating a signal on the basis of the measurement in step b).

22. The method of generating an electrical signal according to claim 21, in which step a) is a step of passing a current through the first conductor designed to come into contact with the second conductor at the point of contact as the board overlaps another board.

23. The method of generating an electrical signal according to claim 21, in which step b) is a step of measuring the resistance of a portion of the first conductor, this portion being on one side of the point of contact.
